(19) United States
(12) Patent Application Publication
(10) Pub. No.: US 2026/0343173 A1
(43) Pub. Date: Oct. 29, 2026

(54) TRANSMISSION TO A POSITIONING ENTITY OF INFORMATION RELATING TO THE SIZE OF AN OBJECT THAT IS TO BE POSITIONED

(71) Applicant: Sony Group Corporation, Tokyo (JP)

(72) Inventors: Johan HILL, Lund (SE); Jose FLORDELIS, Lund (SE); Yujie ZHANG, Lund (SE); Basuki PRIYANTO, Lund (SE); Anders BERGGREN, Lund (SE)

(21) Appl. No.: 19/123,359

(22) PCT Filed: Oct. 2, 2023
(86) PCT No.: PCT/EP2023/077191

§ 371 Date: Apr. 22, 2025

(30) Foreign Application Priority Data
Nov. 4, 2022 (SE) 2251282-6

(51) Int. Cl. H04W 4/021; G01S 5/00; G08G 1/16; H04W 4/02; H04W 4/40; H04W 4/90

(52) U.S. Cl. CPC H04W 4/021; G01S 5/0072; G08G 1/161; G08G 1/166; H04W 4/025; H04W 4/40; H04W 4/90

(57) ABSTRACT

Disclosed is a method, performed in a wireless device, WD, for positioning of the WD. The method comprises communicating a location reference signal. The method comprises transmitting, to a positioning node, a boundary message indicative of one or more geometric parameters related to a physical size of an object associated with the WD. The location reference signal and the boundary message are transmitted using a same radio access technology.

The present disclosure pertains to the field of wireless communications. The present disclosure relates to methods for positioning of a wireless device, such as for positioning of an object associated with the wireless device, a related wireless device and a related positioning node.

### BACKGROUND

In 3^{rd} Generation Partnership Project (3GPP) based positioning, a location of a wireless device (WD) to be positioned are estimated based on a location of an antenna, such as antenna panels, of the WD. Different methods are defined for 3GPP-based positioning, most legacy methods being based upon a traditional approach of utilizing fixed transmission points (TRPs) and their locations as references. It has recently been decided that 3GPP sidelink (SL) communication will also have a positioning feature. Sidelink communication has been used as part of 3GPP New Radio (NR) Vehicle to Everything (V2X). In the NR V2X context, a radio network node communicates directly with the WD using the Uu interface. The WD in V2X can be a roadside unit (RSU) (such as a traffic light or a signpost with a communication module attached to it), a car having a communication module, a WD associated with a pedestrian and/or cyclist (a so-called vulnerable road user (VRU)), etc. The WDs can communicate with each other via a sidelink, such as using the PC5 interface. Communication between UEs uses radio resources. If the WDs are within cell coverage of the radio network node, the radio network node allocates the radio resources. For example, the radio network node can define the radio resources to be used for SL communication. This may be referred to as Mode-1.

For SL positioning, the WD may be configured to transmit sidelink positioning reference signals (SL-PRSs) in a PC5 link, similarly to downlink positioning reference signals (DL-PRS) and uplink sounding reference signals (UL-SRS) over a Uu link between the WD and a radio network node. The WD to be positioned, which may also be referred to as a target WD, may receive the SL-PRSs and may perform positioning measurements on the SL-PRSs. SL positioning will have a feature of absolute positioning, but also a feature of ranging, where relative distances or directions between WDs are measured.

Previously, the standard size of a WD has been the size of a smartphone. However, in recent years, the form factor of a WD has changed with the introduction of Internet of Things (IoT). By the incorporation of WDs into other objects, the WD may be associated with a tiny object, such as a mobile phone or an RFID tag, but also an object larger than a mobile phone, such as home appliances, vehicles, etc. Simultaneously, the accuracy for 3GPP-based positioning has also gradually improved over the years or, more specifically, over 3GPP releases and types of wireless devices. The positioning accuracy has, during the last couple of years, improved from several tens of meters for LTE-based IoT device types down to tens of centimeters for the latest 3GPP Rel. 17 NR specification supporting commercial requirements.

However, the increase of positioning accuracy in combination with the increase in WD size, such as the size of the object associated with the WD, may lead to the positioning of the WD being narrower than the actual size of the object WD. This may lead to an inaccurate determination of a position of the target WD. This is especially problematic during, for example, a SL V2X scenario, where an inaccurate determination of a position of an object to which a WD is attached in relation to other WDs, such as during ranging of the WD, can lead to collisions.

### SUMMARY

Accordingly, there is a need for devices and methods for positioning of the WD, which may mitigate, alleviate, or address the shortcomings existing and may provide a more accurate determination of the position of the WD.

Disclosed is a method, performed in a wireless device, WD, for positioning of the WD, such as for positioning of an object associated with the WD. The method comprises communicating a location reference signal. The method comprises transmitting, to a positioning node, a boundary message indicative of one or more geometric parameters related to a physical size of an object associated with the WD. The location reference signal and the boundary message are transmitted using a same radio access technology.

Further, a wireless device comprising memory circuitry, processor circuitry, and a wireless interface is provided. The wireless device is configured to perform any of the methods disclosed herein.

It is an advantage of the present disclosure that the actual size and the boundaries of the object associated with the WD can be considered during the positioning procedure of the WD. By signaling the boundary message comprising the one or more geometric parameters of the object, the WD can inform other nodes participating in the positioning procedure about the boundaries of the object associated with the WD. For example, for a V2X scenario, where the object associated to the WD may be a vehicle, the size of a vehicle and/or the boundaries of the vehicle in relation to the actual determined position of the WD can be signaled. This allows the other nodes to more accurately determine a distance between the vehicle, such as the outer boundaries of the vehicle, and a second WD, and/or object associated with the second WD. By enabling a more accurate determination of the position of the object associated with the WD collisions between the object associated with the WD and other objects related to other WDs can be avoided. Moreover, by signaling the object's boundary, the need to determine the locations of various antenna panels arranged on the object can be reduced, which reduces latency of the positioning procedure.

Disclosed is a method, performed in a positioning node, for positioning of a WD, such as for positioning of an object associated with the WD. The method comprises initiating a communication of a location reference signal. The method comprises receiving, from the WD, a boundary message indicative of one or more geometric parameters related to a physical size of an object associated with the WD. The location reference signal and the boundary message are received using a same radio access technology.

Further, a positioning node comprising memory circuitry, processor circuitry, and a wireless interface is provided. The positioning node is configured to perform any of the methods disclosed herein.

It is an advantage of the present disclosure that the actual size and the boundaries of the object associated with the WD can be considered during the positioning procedure of the WD. By receiving the boundary message comprising the one or more geometric parameters of the object, the positioning node can be informed about the boundaries of the object associated with the WD. For example, for a V2X scenario, where the object associated to the WD may be a vehicle, the size of a vehicle and/or the boundaries of the vehicle in relation to the actual determined position of the WD can be signaled. This allows positioning node to more accurately determine a distance between the vehicle, such as the outer boundaries of the vehicle, and a second WD, and/or object associated with the second WD. By enabling a more accurate determination of the position of the object associated with the WD collisions between the object associated with the WD and other objects related to other WDs can be avoided. Moreover, by signaling the object's boundary, the need to determine the locations of various antenna panels arranged on the object can be reduced, which reduces latency of the positioning procedure.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example network node and an example wireless device according to this disclosure,

FIG. 2 illustrates an object associated with the wireless device according to this disclosure,

FIG. 3 is a signaling diagram illustrating an example message exchange for positioning of a wireless device according to this disclosure,

FIGS. 4A-4F are signaling diagrams illustrating example message exchanges for positioning of a wireless device according to this disclosure,

FIG. 5 is a flow-chart illustrating an example method, performed by a wireless device, for positioning of the wireless device according to this disclosure,

FIG. 6 is a flow-chart illustrating an example method, performed by a wireless node, for positioning of a wireless device according to this disclosure,

FIG. 7 is a block diagram illustrating an example wireless device according to this disclosure, and

FIG. 8 is a block diagram illustrating an example wireless node according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

The figures are schematic and simplified for clarity, and they merely show details which aid understanding the disclosure, while other details have been left out. Throughout, the same reference numerals are used for identical or corresponding parts.

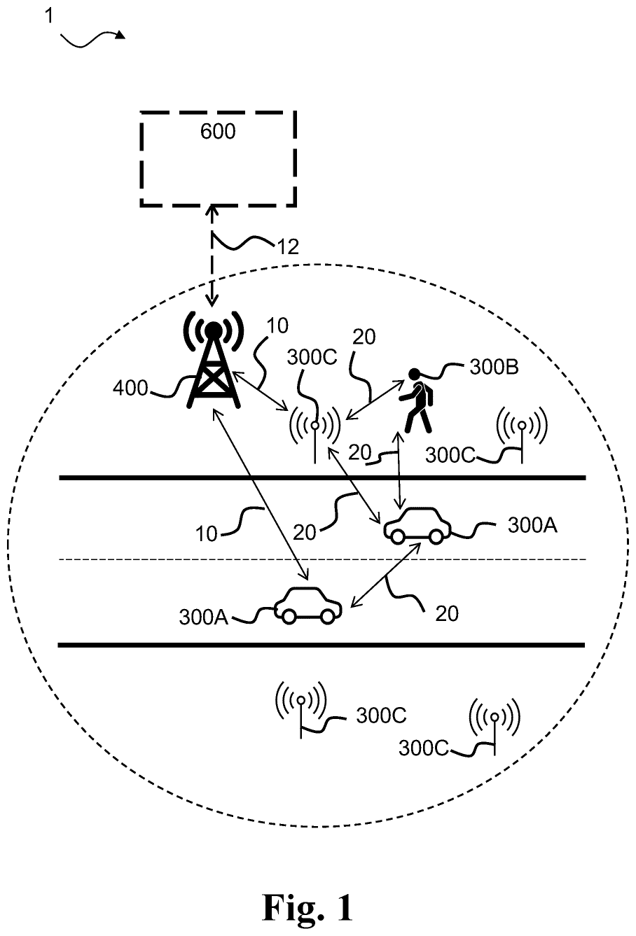

FIG. 1 is a diagram illustrating an example wireless communication system 1 comprising an example core network (CN) node 600, an example radio network node 400 and one or more example wireless devices 300A, 300B, 300C according to this disclosure.

As discussed in detail herein, the present disclosure relates to a wireless communication system 1 comprising a cellular system, for example, a 3GPP wireless communication system. The wireless communication system 1 comprises one or more wireless devices 300A, 300B, 300C and/or a network node 400 and/or a CN node 600.

A radio network node disclosed herein refers to a radio access network (RAN) node operating in the radio access network, such as a base station, an evolved Node B, eNB in 3GPP Long Term Evolution (LTE), gNB in 3GPP New Radio (NR). A gNB may have one or more Transmission and Reception Points (TRPs). In one or more examples, the RAN node is a functional unit which may be distributed in several physical units.

A CN node 600 disclosed herein refers to a network node operating in the core network, such as in the Evolved Packet Core Network, EPC, and/or a 5G Core Network, 5GC. Examples of CN nodes in EPC include a Mobility Management Entity (MME), and a Location Management Function (LMF).

A wireless device may refer to a mobile device and/or a user equipment, UE. In one or more examples herein, a wireless device may refer to a communication equipment comprising one or more antennas and being arranged to an object, such as to a vehicle, a drone, a traffic light, a home appliance etc.

The wireless communication system 1 described herein may comprise one or more wireless devices 300A, 300B, 300C, and/or one or more radio network nodes 400, such as one or more of: a base station, an eNB, a gNB and/or an access point.

The wireless devices 300A, 300B, 300C may be configured to communicate with the radio network node 400 via a wireless link (or radio access link) 10, such as an air interface (Uu interface). The wireless devices 300A, 300B, 300C may be configured to communicate directly with each other via a sidelink 20, such as via a PC5 interface. The sidelink 20 is a wireless link. In one or more example methods, a positioning of a WD may be performed using Uplink (UL) and/or Downlink (DL) procedures via the Uu interface, in which the position of the WD is determined in relation to the radio network node 400. In one or more example methods, a positioning of a WD may be performed using SL positioning procedures via the PC5 interface, where the position of the WD is determined in relation to a second WD having a known position.

The core network node 600 may be configured to communicate with the radio network node 400 via a link 12, such as a wired and/or wireless link, and/or with the one or more wireless devices 300A, 300B, via the radio network node 400.

Sidelink communication may be used as part of NR-V2X. The WDs 300A, 300B, 300C in V2X can be stationary WDs 300C, such as a Road Side Unit (RSU), or non-stationary WDs, such as WDs 300A associated with objects such as vehicles having a communication module, or Vulnerable Road User (VRU), such as WDs 300B carried by a pedestrian and/or a cyclist. The WDs 300A, 300B, 300C can communicate with each other over the sidelink 20, such as via the PC5 interface. The communication between the WDs 300A, 300B, 300C uses radio resources. In case the WDs 300A, 300B, 300C are within cell coverage of the radio network node 400, the radio resources may be allocated by the radio network node 400. For example, the radio network node 400 may define the radio resources to be used for the sidelink communication between the WDs 300A, 300B, 300C. The radio network node 400 may grant the sidelink resources to a sidelink transmitting (Tx) WD via a downlink control channel. The Tx WD may be the WD that initiates the sidelink communication with, such as transmits sidelink positioning reference signals to, a receiving (Rx) WD. Prior to the transmission of sidelink communication, the Tx WD may transmit a sidelink control channel so that the sidelink Rx WD is aware of the upcoming sidelink transmission and is able to receive and decode it. The sidelink positioning procedure may be used to perform ranging between one or more of the WDs 300A, 300B, 300C, where relative distances or directions between the WDs are measured.

The operation of sidelink resource allocation can be in two modes. In a first resource allocation mode, which may be referred to as Mode 1 resource allocation, the radio network node 400 performs the scheduling for the sidelink communications. This is typically the case when the sidelink WDs 300A, 300B, 300C are operated in-coverage of the radio network node 400. In a second resource allocation mode, which may be referred to as Mode 2 resource allocation, the WDs 300A, 300B, 300C, such as the Tx WD, autonomously selects the resources after performing a carrier-sensing operation.

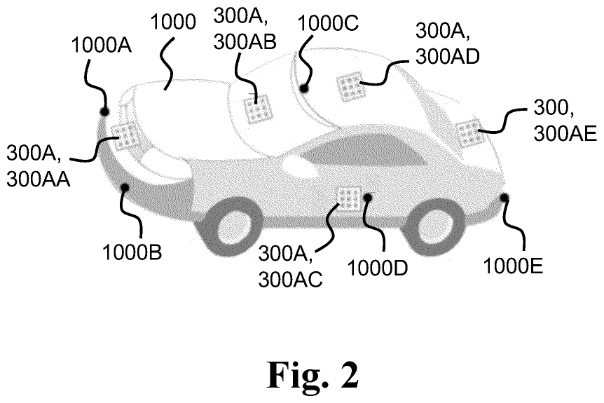

FIG. 2 illustrates an object 1000 associated with a WD 300A according to the current disclosure. In this example the object 1000 is a vehicle, such as a car. The WD 300A may comprise a plurality of antenna panels 300AA, 300AB, 300AC, 300AD, 300AE. When performing a positioning estimation of the WD 300A is performed, it is the location of the antenna panels transmitting or receiving the positioning signals, such as location reference signals, that determines the estimated position. This is due to the position of the device being determined based on, for example, a propagation time of the positioning signals to or from the antenna panel from or to a respective antenna panel of a positioning node, such as to a radio network node and/or a second WD participating in the positioning procedure. The antenna panel location becomes even more essential given modern WDs' higher accuracy and larger form factors of the objects associated with the WDs. In the example shown in FIG. 2, the vehicle has different mounting points and/or positions for the antenna panels 300AA, 300AB, 300AC, 300AD, 300AE. These mounting points may herein be referred to as antenna reference points (ARPs). The ARPs may be reference points within a global coordinate system (GCS) or a local coordinate system (LCS), such as a coordinate system of the object. Using for example antenna panel 300AD to measure the distance to a VRU, such as a WD 300B in FIG. 1, in front of the vehicle could lead to a significant static error in case the WD 300A is assumed to be for example a mobile phone, since a boundary of the vehicle extends far beyond the size of a mobile phone. This could lead to a static error of several meters which could be the difference between causing and avoiding a collision between the vehicle associated with WD 300A and the VRU. If the 3GPP accuracy requirement for positioning is 30 cm, a two meter static error introduced by panel 300AD to the front boundary of the vehicle could thus mean the difference between life and death for a VRU located in front of the vehicle.

In the example shown in FIG. 2, the object 1000, such as the vehicle, is equipped with a Distributed Antenna System (DAS) with antenna panels 300AA, and 300AE mounted at a front and a rear bumper, antenna panel 300AD mounted at a rooftop, antenna panel 300AB mounted at a windshield, and antenna panel 300AC mounted at one of the front doors. By performing localization for all the antennas, a better picture would be possible: one could have some knowledge of the location of the object's boundaries. However, it means five different measurements, to each of the panels, with subsequent signal processing. Using a DAS thus requires a large amount of processing power and is cost intensive, since a plurality of antenna panels has to be arranged on the object 1000.

To overcome the drawbacks of using the DAS, the current disclosure provides a solution in which signaling comprising geometric parameters indicative of a boundary of an object may be communicated. The object 1000 may be positioned using 3GPP positioning methods, such as UL-based, DL-based and/or SL-based positioning methods. Instead of just sharing the location of the antenna panels, or reporting antenna reference points on the vehicle, the solution according to this disclosure provides information about an outer boundary of the object associated with the WD to be positioned. In the examples provided in this disclosure, the object is described as a vehicle. However, the object associated with the WD may also be other objects participating in a positioning procedure, such as fixed units along a road, movable static objects such as shipping containers, robots in a factory environment, moving trucks, or aircrafts, such as drones. By keeping track of the object's outer boundary, the need to calculate the locations of various antenna panels on the object can be reduced.

In one or more example methods, the geometric parameters indicative of the boundary of the object 1000, may comprise coordinates of a plurality of outer sections of the object 1000, such as reference points 1000A, 1000B, 1000C, 1000D, and 1000E of the object 1000, relative to one or more ARPs. In one or more example methods, the coordinates of the outer part of the object 1000, such as the points 1000A, 1000B, 1000C, 1000D, and 1000E, are expressed as points of the GCS or LCS, such as a coordinate system of the object 1000. Positioning procedures typically use the location of an antenna panel of the WD to obtain the position of the WD. However, by providing a location of one or more reference points 1000A, 1000B, 1000C, 1000D, 1000E of the object 1000 associated with the WD, the positioning procedure may determine the position of the reference point of the object 1000, if its location relative to the antenna panels of the WD is known. For example, the reference point of the object can be a three-dimensional point within the boundaries of the object, such as of the vehicle. If, for example, the location of the ARP of the WD 300A is known with respect to the boundaries of the object 1000, entities trying to position the WD 300 can determine the location of various reference points along the boundary of the object 1000. In one or more examples, by pre-configuring the boundaries of the object, such as in relation to the ARP of the WD associated with the object, only one 3-dimensional coordinate, or reference point, needs to be communicated to entities participating in a positioning procedure of the WD (such as other WDs, such as RSUs, radio network nodes, and or core network nodes, such as an LMF, etc.), for these entities to have full knowledge of the position of the object boundaries.

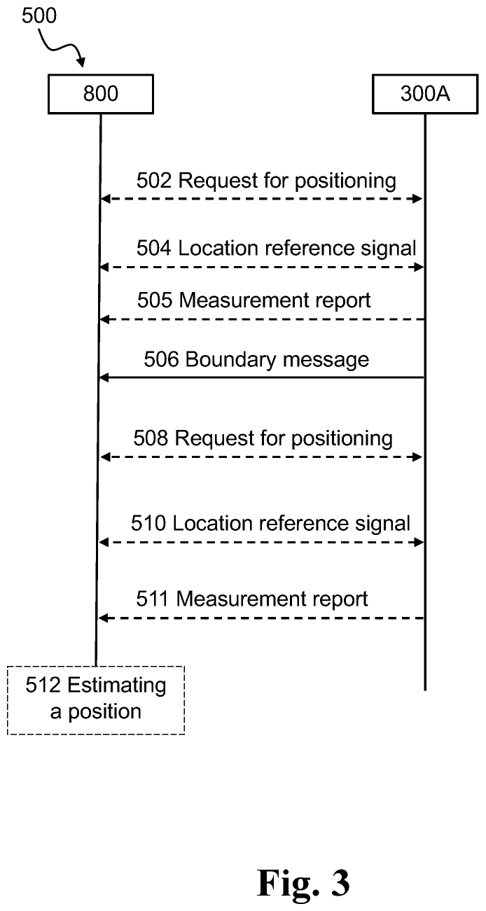

FIG. 3 illustrates an example message exchange 500 between a wireless device 300A and a positioning node 800 for positioning of the wireless device 300A according to this disclosure. The positioning node can be seen as a node participating in a positioning procedure of the WD, such as of the target WD. In one or more example methods, the positioning node is a wireless node, such as a second WD, for example a RSU, and/or a radio network node. In one or more example methods, the positioning node is an LMF.

To initiate the positioning procedure the WD 300A and the positioning node 800 communicate a request for positioning 502, 508. The request for positioning 502 may communicated as a first step of the positioning procedure, such as being communicated as a request for positioning 502. In one or more example methods, communicating the request for positioning 502 of the WD 300A comprises the positioning node 800 initiating the positioning procedure by transmitting the request for positioning to the WD 300A, and the WD 300A receiving the request for positioning 502. In this case the positioning node 800 may be the positioning initiating node.

In one or more example methods, communicating the request for positioning 502 of the WD 300A comprises the WD 300A initiating the positioning procedure by transmitting the request for positioning to the positioning node 800, and the positioning node 800 receiving the request for positioning 502. In this case the WD 300A may be the positioning initiating node.

In response to communicating the request for positioning 502 of the WD 300A, the WD300A and the positioning node 800 communicate a location reference signal 504, such as a positioning reference signal (PRS) transmitted in the UL and/or the DL when the positioning node 800 is a radio network node, and a sidelink reference signal transmitted via the PC5 interface when the positioning node 800 is a second WD.

In one or more example methods, communicating the location reference signal 504 comprises the positioning node 800 transmitting the location reference signal to the WD 300A, for the WD 300A to measure on. The WD 300A may receive the location reference signal 504 and may perform measurements on the location reference signal.

In one or more example methods, communicating the location reference signal 504 comprises the WD 300A transmitting the location reference signal to the positioning node 800, for the positioning node 800 to measure on. The positioning node 800 may receive the location reference signal 504 and may perform measurements on the location reference signal.

In one or more example methods, such as when the positioning node 800 transmits location reference signals to the WD 300A, the WD 300A may perform measurements on the location reference signals and may transmit a measurement report 505 to the positioning node 800. The WD 300A transmits a boundary message 506 to the positioning node 800. The boundary message 506 is indicative of one or more geometric parameters related to a physical size of an object associated with the WD, such as with a boundary of the object associated with the WD. The one or more geometric parameters can be used to determine a position of the boundaries of the object based on positioning measurements performed using an antenna panel of the WD arranged on the object. The one or more geometric parameters may comprise one or more of:
one or more dimensions of the object,
a relative location between an antenna reference point and one or more reference points of the object,
an antenna reference point coordinate within the object,
an antenna reference point identifier,
an orientation parameter, and
a boundary identifier indicative of a predetermined type of boundary object.

The boundary message may be transmitted by the WD 300A subsequent to communicating the request for positioning 502. In one or more example methods, the boundary message may be transmitted in response to receiving the request for positioning from the positioning node 800 or in response to receiving the location reference signal from the positioning node 800. In one or more example methods, the boundary message may be transmitted together with the request for positioning transmitted to the positioning node 800.

In one or more example methods, the boundary message 506 may be transmitted in conjunction with the measurement report 505, such as comprised in the measurement report 505 or in a subsequent message. The measurement report 505 may comprise one or more of a Reference Signal Time Difference (RSTD), a time difference of arrival (TDoA), such as a DL Observed Time Difference of Arrival (OTDoA), a time of arrival (ToA), a round trip time (RTT), an angle-based measurement (such as, Angle of Arrival (AOA) and/or Angle of Departure (AOD)), and a Received Signal Strength Indication (RSSI).

In one or more example methods, the boundary message 506 may be transmitted prior to communicating a request for positioning 508 with the positioning node 800 and/or prior to communicating a location reference signal 510 with the positioning node 800. The request for positioning 508 is the same message as the request for positioning 502 but is transmitted after receiving the boundary message 506 instead of prior to receiving the boundary message 506.

The WD 300A may, in one or more example methods, transmit the boundary message as part of a pre-configuration procedure, such as part of a network registration procedure of the WD 300A. Thereby, the positioning node 800 may be preconfigured with the boundary information of the object associated with the WD 300A prior to performing the positioning procedure.

Upon the boundary message 506 being transmitted prior to communicating the request for positioning 508 with the positioning node 800 and/or prior to communicating the location reference signal 510 with the positioning node 800, the transmission of the boundary message 506 can be followed by the WD 300A and the positioning node 800 communicating the request for positioning for positioning 508 of the WD. In one or more example methods, communicating the request for positioning 508 of the WD 300A comprises the positioning node 800 transmitting the request for positioning to the WD 300A. In one or more example methods, communicating the request for positioning 508 of the WD 300A comprises the WD 300A transmitting the request for positioning to the positioning node 800.

In response to communicating the request for positioning 508 of the WD 300A, the WD300A and the positioning node 800 communicate a location reference signal 510, such as a PRS transmitted in the UL and/or the DL when the positioning node 800 is a radio network node, and a sidelink reference signal transmitted via the PC5 interface when the positioning node 800 is a second WD.

In one or more example methods, communicating the location reference signal 510 comprises the positioning node 800 transmitting the location reference signal 510A to the WD 300A, for the WD 300A to measure on.

In one or more example methods, communicating the location reference signal 510 comprises the WD 300A transmitting the location reference signal 510B to the positioning node 800, for the positioning node 800 to measure on.

In one or more example methods, such as when the positioning node 800 transmits location reference signals to the WD 300A, the WD 300A may perform measurements on the location reference signals and may transmit a measurement report 511 to the positioning node 800.

The positioning node 800, in one or more example methods, determine 512 the position of the object associated with the WD 300A based on the boundary message, such as the geometric parameters comprised in the boundary message, and/or one or more of the location reference signals and the measurement report.

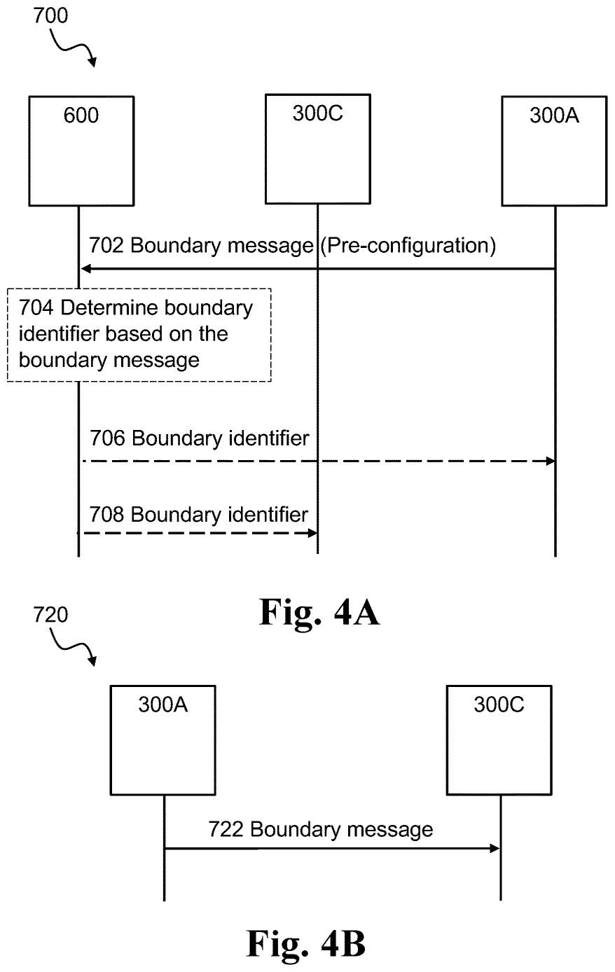

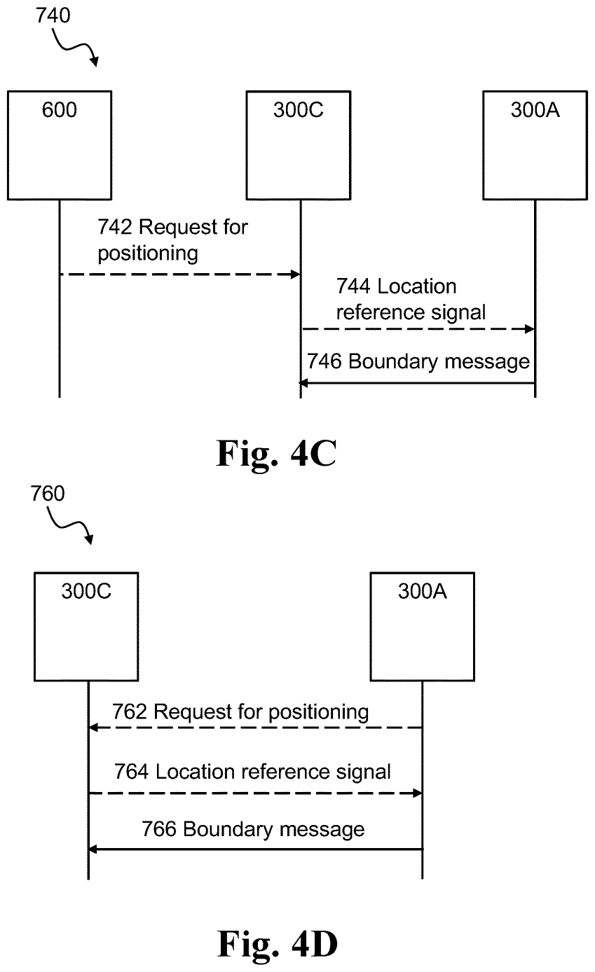

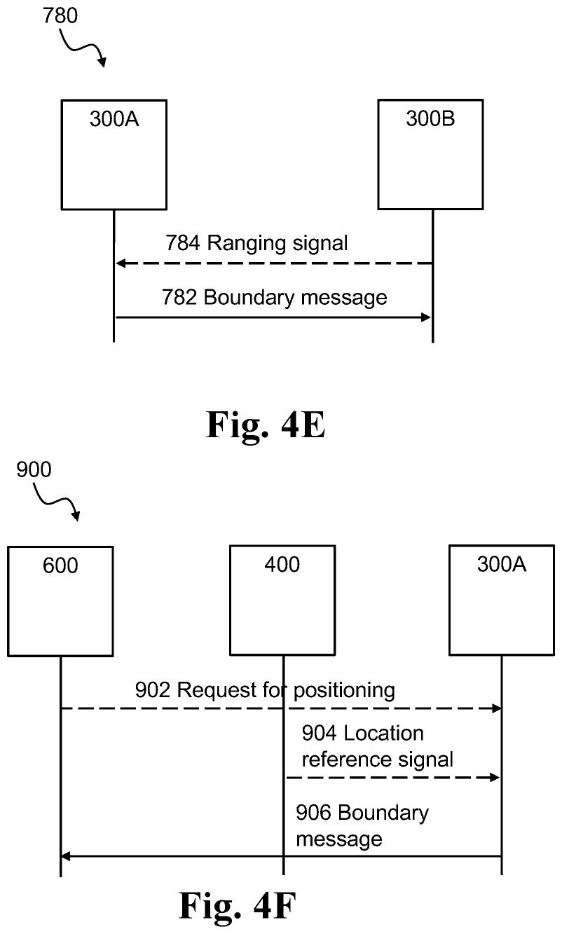

FIGS. 4A-4F illustrate example message exchanges associated with the transmission of the boundary message. The message exchanges illustrated in FIGS. 4A-4F may take place subsequently to the exchange of the messages 502-505 in FIG. 3, or prior to the exchange of the messages 508-511 in FIG. 3 FIG. 4A illustrates an example message exchange 700 between a LMF 600, a second WD 300C, such as an RSU, and a WD 300A for positioning of the WD 300A according to this disclosure. FIG. 4A illustrates a configuration of the WD 300A and the second WD 300C with a boundary identifier 706, 708. The boundary identifier may be associated with boundaries of the WD 300A as coordinates and/or identifiers associated with pre-configured boundaries.

The WD 300A transmits, to a core network node 600, such as the LMF, a boundary message 702. The boundary message 702 may comprise one or more geometric parameters related to a physical size of an object associated with the WD 300A.

In one or more examples, the boundary message 702 is transmitted as part of a pre-configuration procedure, such as when the WD 300A connects to the wireless communication network. In one or more examples, the boundary message 702 comprises one or more pre-configured geometrical parameters. The one or more pre-configured geometrical parameters may comprise one or more antenna reference point (ARP) coordinates associated with the object, in which each of the one or more ARP coordinates may be placed and/or mounted in different locations of the object. In one or more examples, the one or more pre-configured geometrical parameters may comprise a boundary identifier associated with a predetermined type of the object associated with the WD 300A. The boundary identifier may identify the boundary shape of the object associated with the WD 300A. For example, when the object associated with the WD 300A is a vehicle, the boundary identifier can refer to a small and/or midsize and/or big vehicle. In some examples, the boundary identifier may refer to a vehicle model.

In one or more examples, the WD 300A informs the LMF 600 about one or more geometric parameters related to a physical size of an object associated with the WD 300A. For example, the WD 300A can inform the LMF 600 about its boundaries (such as, edges and/or outer sections of the object associated with the WD 300) in relation to an antenna reference point and/or one or more reference points of the object associated with the WD 300A. In one or more examples, the boundary message can be transmitted via radio resource control (RRC) protocol and/or LTE positioning protocol (LPP). In other words, the boundary message may be transmitted using a RRC layer and/or an LPP layer.

When the boundary message 702 comprises the one or more ARP coordinates associated with the object, the LMF 600 may determine 704, based on the boundary message 702, a boundary identifier. Stated differently, the LMF 600 may determine a boundary shape type of the object and/or associate such boundary shape type with a boundary identifier. For example, the LMF 600 can generate, based on the one or more ARP coordinates, an approximate boundary shape of the object.

In one or more examples, the LMF 600 receives, from the WD 300A, the boundary message 702 comprising the one or more ARP coordinates associated with the object and/or the boundary identifier.

In one or more examples, the LMF 600 transmits, to the WD 300A, the boundary identifier 706 associated with the object.

In one or more examples, the LMF 600 transmits, to the second WD 300C, the boundary identifier 708. The LMF 600 may configure the second WD 300C with the boundary identifier. The LMF 600 may transmit, to the second WD 300C, the one or more ARP coordinates associated with the object in addition to the boundary identifier.

In one or more examples, the second WD 300C, based on the boundary identifier 708 and/or the one or more ARP coordinates associated with the object, can determine position of the object of the WD 300A in relation to its location. In other words, the second WD 300C may take a role of a location server. The boundary identifier 706 may be same as boundary identifier 708.

FIG. 4B illustrates an example message exchange 720 between a WD 300A and a second WD 300C, such as an RSU according to this disclosure. FIG. 4B illustrates a transmission of a boundary message to the second WD 300C and/or one or more second devices (such as, devices which are part of a sidelink positioning group). The WD 300A may configure the second WD 300C and/or the one or more second devices by transmitting boundaries of an object associated the WD 300A as coordinates and/or identifiers without involvement of a radio network node, such as in out-of-coverage scenarios.

In one or more examples, the WD 300A transmits, to the second WD 300C, a boundary message 722. The boundary message 722 may comprise one or more geometric parameters related to a physical size of an object associated with the WD 300A. In one or more examples, the boundary message 722 comprises one or more pre-configured geometrical parameters. The one or more pre-configured geometrical parameters may comprise one or more ARP coordinates associated with the object, in which each of the one or more ARP coordinates may be placed and/or mounted in different locations of the object.

In one or more examples, the one or more pre-configured geometrical parameters may comprise a boundary identifier associated with a predetermined type of the object associated with the WD 300A. The boundary identifier may be transmitted, by the WD 300A, when a memory of the second WD 300C and/or the one or more second wireless devices comprise a boundary object list, such as a list including one or more ARP coordinates associated with one or more objects (such as, boundary objects) received from one or more WDs previously measured and positioned. In one or more examples, the second WD 300C and the one or more second WDs may determine, based on previous boundary messages from one or more WDs previously measured and positioned, a boundary identifier. The boundary identifier may identify the boundary shape of the object associated with the WD 300A. The second WD 300C and the one or more second WDs may determine a boundary shape type of the object and/or associate such boundary shape type with a boundary identifier.

In one or more examples, the second WD 300C and/or the one or more second WDs, based on the boundary identifier and/or the one or more ARP coordinates associated with the object, can determine position of the object of the WD 300A in relation to its and/or their location.

FIG. 4C illustrates an example message exchange 740 between a LMF 600, a second WD 300C, such as an RSU, and a WD 300A for positioning of the WD 300A according to this disclosure. FIG. 4C illustrates a Sidelink Mode-1 based positioning with a request for positioning the WD 300A. Put differently, a radio network node, such as radio network node 400 of FIG. 1, may allocate resources (such as, time/frequency resources) for a sidelink communication. For example, the LMF 600 communicates with the second WD 300C via the radio network node.

In one or more examples, the LMF 600 transmits, to the second WD 300C, a request for positioning 742 of the WD 300A. The LMF 600 may be seen as a positioning initiating node.

In one or more examples, the second WD 300C transmits, to the WD 300A, a location reference signal 744. Put differently, the second WD 300C supports the WD 300A in acquiring its position by transmitting the location reference signal 744 and/or performing positioning determination of the WD 300A.

In one or more examples, the WD 300A transmits, to the second WD 300C, a boundary message 746. The boundary message 746 may be transmitted in conjunction with a measurement report. For example, the WD 300A may be equipped with a plurality of antennas (such as, a plurality of antenna panels) and may be capable of providing the second WD 300C with one or more measurements comprised in a measurement report in respect to one or more of the plurality of antennas. The boundary message 746 may comprise one or more geometric parameters related to a physical size of an object associated with the WD 300A. The one or more geometric parameters may comprise an ARP coordinate within the object and/or a boundary identifier associated with a shape of the object and/or a relative location between an ARP point (such as, comprising an ARP identifier identifying an antenna panel) and one or more reference points of the object and/or a boundary identifier (such as, identifying a boundary shape of the object).

The measurement report may correspond to the measurement reports 505, 511 in FIG. 3, and may comprise one or more of an RSTD, a TDoA, such as a DL OTDoA, a ToA, an RTT, an angle-based measurement (such as, AOA and/or AOD), and an RSSI.

In one or more examples, the second WD 300C may perform, based on the measurement report, the positioning determination of the WD 300A. In some examples, the second WD 300C can transmit, to the radio network node, the measurement report. The position of the WD 300A may be determined by the radio network node.

FIG. 4D illustrates an example message exchange 760 between a second WD 300C, such as an RSU, and a WD 300A for positioning of the WD 300A according to this disclosure. FIG. 4D illustrates a Sidelink Mode-2 based positioning with a request for positioning the WD 300A. The WD 300A and the second WD 300C may operate without involvement of a radio network node. In other words, the WD 300A can autonomously allocate resources (e.g., time/frequency resources) for a sidelink communication.

In one or more examples, the WD 300A transmits, to the second WD 300C, a request for positioning 762. In other words, the WD 300A requires support from the second WD 300C to acquire its position (e.g., location). The second WD 300C supports the WD 300A to acquire its position by transmitting, to the WD 300A, a location reference signal 764 and/or performing positioning determination of the WD 300A.

In one or more examples, the WD 300A transmits, to the second WD 300C, a boundary message 766. The boundary message 746 may be transmitted in conjunction with a measurement report. The boundary message 766 may correspond to boundary message 746. The measurement report may correspond to the measurement reports 505, 511 in FIG. 3, and may comprise one or more of an RSTD, a TDoA, such as a DL OTDoA, a ToA, an RTT, an angle-based measurement (such as, AOA and/or AOD), and an RSSI.

In one or more examples, the second WD 300C may perform, based on the measurement report, the positioning determination of the WD 300A.

FIG. 4E illustrates an example message exchange 780 between a WD 300A and a third WD 300B, such as a WD associated with a VRU, for positioning of the WD 300A according to this disclosure. FIG. 4E illustrates transmission of a measurement report in conjunction with a boundary message by the WD 300A in response to receiving a ranging signal by the third WD 300B (e.g., a pedestrian).

In one or more examples, the third WD 300B transmits, to the WD 300A, a ranging signal 784. The ranging signal 784 may be seen as a location ranging signal and/or location reference signal. The third WD 300B may detect presence of the WD 300A (such as, near to location of the third WD 300B). Upon detecting the presence of the WD 300A, the third WD 300B informs the WD 300A about such detection. For example, the ranging signal can be seen as a request for positioning the WD 300A by the third WD 300B when detected near to the third WD 300B. The ranging signal 784 may enable the third WD 300B to determine position of the WD 300A. The third WD 300B may determine the position of the WD 300A itself or via a second WD (such as second WD 300C, such as an RSU) and/or radio network node (such as, radio network node 400).

In one or more examples, the WD 300A transmits, to the third WD 300B, a boundary message 782. The boundary message 782 may be transmitted in conjunction with a measurement report. The boundary message 782 may correspond to boundary message 746, 766. The measurement report may correspond to measurement report indicated in FIGS. 4C-4D and to measurement reports 505, 511 in FIG. 3.

FIG. 4F illustrates an example message exchange 900 between an LMF 600, a WD 300A and a radio network node 400, for positioning of the WD 300A according to this disclosure. FIG. 4F illustrates an LMF-based positioning of an object associated with the WD 300A. The LMF 600 may determine position of the WD 300A via the radio network node 400.

In one or more examples, the core network node 600, such as the LMF transmits, to the WD 300A, a request for positioning 902 the WD 300A. The request for positioning 902 may be seen as a location request requesting location of the object associated with the WD 300A. In one or more examples, the LMF 600 may be seen as an initiating positioning node. The LMF may initiate positioning of the WD 300A by transmitting, to the WD 300A, the request for positioning 902 via the radio network node 400.

In one or more examples, the radio network node 400 transmits, to the WD 300A, a location reference signal 904. For example, the WD 300A can perform, based on the location reference signal 904, one or more measurements (such as a RSTD measurement and/or a RTT measurement and/or an angle-based measurement and/or any other suitable measurements). A measurement report may comprise the one or more measurements.

In one or more examples, the WD 300A may transmit, to the LMF 600, a boundary message 906. The boundary message 906 may be transmitted in conjunction with the measurement report. Put differently, the WD 300 may transmit, to the radio network node 400, the boundary message and the measurement report. The radio network node 400 may transmit, to the LMF 600, the boundary message and the measurement report. For example, the LMF 600 determines, based on the measurement report and the boundary message 906, the position of the WD 300A. For example, radio network node 400 receives, from the LMF 600, the position of the WD 300A, and transmits the position of the WD 300A to a second WD, such as a second WD 300A, 300B, 300C, such as an RSU, or a VRU, and/or a vehicle.

The boundary message 906 may correspond to boundary message 746, 766, 782. The measurement report may correspond to measurement report indicated in FIGS. 4C-4E and to measurement reports 505, 511 in FIG. 3.

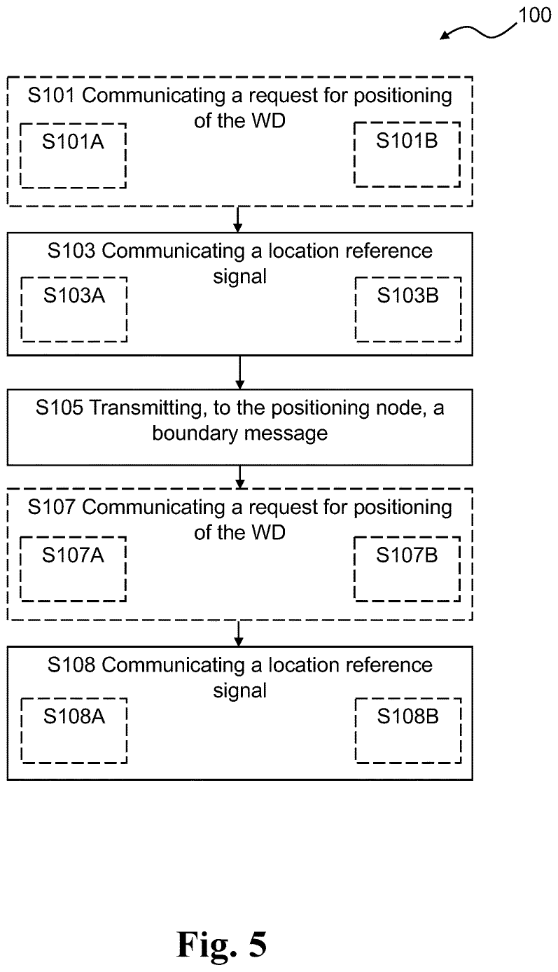

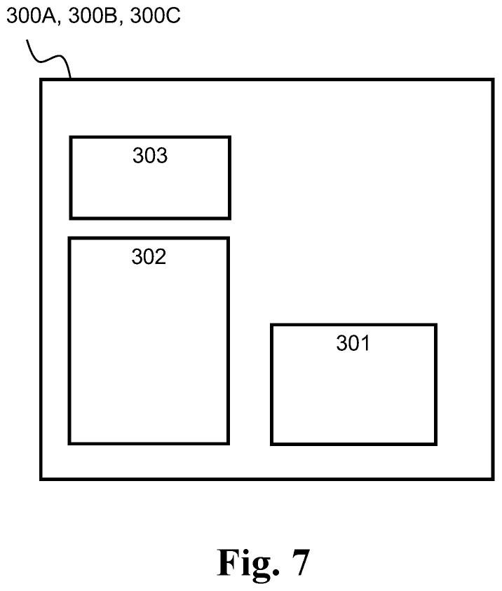

FIG. 5 shows a flow-chart of an example method 100, performed in a WD according to the disclosure, for positioning of the WD. The WD is a WD disclosed herein, such as WD 300A, 300B, 300C of FIG. 1, FIG. 2, FIG. 3, FIGS. 4A-4F and FIG. 7. The WD to be positioned may herein also be referred to as a target WD.

In one or more example methods, the method 100 comprises communicating S101, S107, a request for positioning the WD. In one or more example methods, communicating the request for positioning of the WD comprises receiving S101A, S107A a request for positioning the WD from a positioning initiating node. The positioning initiating node can herein be seen as an entity initiating a positioning procedure for positioning the WD 300A, 300B, 300C. The positioning procedure may be a 3GPP positioning procedure, such as one or more of an UL positioning procedure, a DL positioning procedure, a SL positioning procedure, a Round-Trip-Time (RTT) positioning procedure, and an Observed Time Difference of Arrival (OTDA) positioning procedure. The positioning procedure may not relate to a GPS positioning procedure.

In one or more example methods, communicating the request for positioning of the WD comprises transmitting S101B, S107B a request for positioning the WD to a positioning node, such as a node participating in the positioning of the WD.

In one or more example methods, the positioning initiating node is a radio network node, such as the radio network node 400 of FIG. 1. This may for example be the case when the positioning procedure is an UL and/or DL positioning procedure.

In one or more example methods, the positioning initiating node is a second WD, such as a second WD 300A, 300B, 300C of FIG. 1, such as an RSU. This may for example be the case when the positioning procedure is a SL positioning procedure.

The method 100 comprises communicating S103, S108 a location reference signal. The location reference signal may be one or more of a PRS transmitted in the UL and/or the DL, and a sidelink reference signal transmitted via the PC5 interface. Communicating S103, S108 may comprise transmitting S103A, S108A and/or receiving S103B, S108B the location reference signaling.

The method 100 comprises transmitting S105, to a positioning node, a boundary message indicative of one or more geometric parameters related to a physical size, such as to a geometric boundary, of an object associated with the WD. The location reference signal and the boundary message are transmitted using a same radio access technology, such as using a Bluetooth access technology, WiFi access technology, or a 3GPP access technology. Transmitting using a 3GPP access technology may comprise transmitting using one or more of a 3GPP LPP, a 3GPP RRC protocol, and a 3GPP Layer 1 (L1) protocol. The positioning node can be seen as a node participating in a positioning procedure of the WD, such as of the target WD. In one or more example methods, the positioning node is a wireless node, such as a second WD, for example a RSU, and/or a radio network node. In one or more example methods, the positioning node is an LMF.

In one or more example methods, the one or more geometric parameters comprise coordinates of one or more reference points of the object, such as of an outer section, such as a boundary of the object. The reference point of the object may herein be referred to as an object reference point. The one or more reference points may be reference points, such as the reference points 1000A, 1000B, 1000C, 1000D, 1000E of the object 1000 shown in FIG. 2.

In one or more example methods, the one or more geometric parameters comprise a relative location between an antenna reference point and one or more reference points of the object. In other words, the coordinates of the one or more reference points may be indicated relative to one or more antenna reference points of the object.

In one or more example methods, the coordinates of the one or more reference points may be indicated as coordinates within a GCS or LCS, such as a coordinate system of the object.

In one or more example methods, the one or more geometric parameters comprise one or more dimensions of the object. The geometric parameters may for example indicate that the object has a first extension in a first dimension, a second extension in a second dimension, and a third extension in a third dimension. In one or more example methods, the geometric parameters may define the object as a volume object, such as a box, extending in a plurality of dimensions. The one or more dimensions may be signalled together with a (pre)defined point of the object as an object reference point. In other words, the one or more geometric parameters may indicate the extension of the object in the one or more dimensions in relation to the object reference point.

In one or more example methods, the one or more geometric parameters may comprise an ARP. The ARP may be related to the object reference point. This allows the positioning node to determine a position of the object reference point in relation to the position determined based on the antenna reference point during a positioning procedure.

In one or more example methods, the one or more geometric parameters comprise an antenna reference point coordinate within the object. The antenna reference point coordinate may be indicated as a coordinate within a GCS or LCS, such as within the coordinate system of the object.

In one or more example methods, the one or more geometric parameters comprise an antenna reference point identifier (ARP ID). In case the object comprises a plurality of antenna panels, the one or more geometric parameters may comprise an antenna reference point identifier, identifying the antenna panel in relation to which the object reference point has been determined. By providing the ARP ID, the positioning node may identify the antenna panel out of the plurality of antenna panels to be used for correctly positioning the boundaries of the object.

In one or more example methods, the one or more geometric parameters comprise an orientation parameter. The orientation parameter may indicate whether an object reference point and/or an ARP is located in the front, the back or on a side, such as a left side or right side, of the object. In one or more example methods, the orientation parameter indicates the direction of orientation of the object, such as a geographic orientation. In other words, the orientation parameter may indicate a geographic direction that for example a front of the object is pointing in, such as is directed towards.

In one or more example methods, the one or more geometric parameters comprise a boundary identifier (ID) indicative of a predetermined type of boundary object, such as a predetermined shape of the boundary object. In one or more example methods, a plurality of different boundary objects may be predetermined, such as a vehicle, a RSU, etc. Each of the predetermined boundary objects may have a predetermined geometric size. In one or more example methods, the boundary ID may be indicative of subcategories of the predetermined boundary objects, such as based on the size of the predetermined objects. The boundary object vehicle may for example comprise the categories small sized vehicle, medium sized vehicle, large sized vehicle, such as small sized car, medium sized car, large sized car, small sized truck, medium sized truck, large sized truck, small sized bus, medium sized bus, large sized bus, etc. Each of the boundary objects and/or subcategories of boundary objects may have a predetermined size or volume. The selected boundary object is rounded upwards to the closest boundary. In other words, if the boundaries of the object associated with the WD is larger than for example a medium sized vehicle, the object associated with the WD is classified as the next sized vehicle, such as a large sized vehicle and the boundary message would comprise the boundary ID associated with the large sized vehicle. In one or more example methods, the preconfigured boundary objects can be even finer-grained, such as designating specific car brands and/or models. Each car brand and/or model may thus have its own predetermined boundary ID, which can be indicated in the boundary message.

In one or more example methods, the boundary message may comprise a boundary capability indication indicative of whether the antenna is located at the boundary of the object or distant from the boundary of the object. The boundary capability indication may in one or more example methods indicate whether the WD is with or without boundary. Without boundary can herein be seen as the transmission and/or reception point, such as the antenna panel of the WD, is located at the outer part of the object (such as on a door of a vehicle, a bumper of the vehicle, etc).

In one or more example methods, the boundary message comprises a velocity parameter indicative of a direction and speed of the object. The velocity parameter may for example indicate whether the closest point of the object, such as the point of the object closest to a second WD, is moving closer to or away from the second WD. In one or more example methods, instead of signaling a complete boundary of the object, only the closest point to the second WD may be communicated in the boundary message.

The object associated with the WD may be seen as an object connected to, attached to, being collocated with, and/or moving together with the WD.

In one or more example methods, the request for positioning the WD is communicated S101, such as received S101A or transmitted S101B, prior to transmitting S105 the boundary message. In one or more example methods, the boundary message is transmitted in response to receiving S101A the request for positioning the WD. In one or more example methods, the boundary message is transmitted together with position coordinates in a positioning estimation report. For example, the positioning estimation report may indicate what boundaries or boundary ID a position coordinate is related to. In other words, the WD may report its estimated position and information related to the boundary of the object associated with the WD, such as the geometric parameters related to the physical size of the object. In one or more example methods, the positioning estimation report may be transmitted when the WD has measured on a location reference signal and has determined its position based on the measurement.

In one or more example methods, the boundary message is transmitted together with a measurement report, such as a positioning measurement report. For example, the WD may be equipped with multiple antenna panels and may thus have different measurements with respect to different antenna panels. In the measurement report, the WD may indicate the geometric parameters related to the physical size of the object, such as reference coordinates of the boundary of the object or a boundary ID, and the association between an ARP ID and the geometric parameters related to the physical size of the object. In one or more example methods, the measurement report may be transmitted when the WD has measured on a location reference signal transmitted from a positioning node and transmits the measurement report back to the positioning node for enabling the positioning node to determine the actual position of the WD based on the measurement report.

In one or more example methods, the request for positioning the WD is communicated S107, such as received S107A and/or transmitted S107B subsequent to transmitting S105 the boundary message.

In one or more example methods, the boundary message may be transmitted as a part of, such as comprised in, the request for positioning of the WD, when the method comprises transmitting S101B, S107B the request. This may for example be the case when the request for positioning is initiated from the object itself, such as from the WD associated with the object. In this case, the WD may act as a positioning initiating node. For example, the positioning request could indicate any of the geometric parameters mentioned herein, such as the use of a specific boundary or a boundary ID and a corresponding reference point.

In one or more example methods, the boundary message is transmitted as part of a pre-configuration procedure, such as part of a network registration procedure of the WD. The WD may for example transmit the boundary message, to an LMF, to set up a predetermined type of boundary object associated with the WD, such as the object being a vehicle. This communication can be at the RRC level or LPP level. The WD may, in one or more example methods, transmit the boundary message to the LMF during the pre-configuration procedure, which can enable the LMF to subsequently provide the geometric parameters related to a physical size of an object associated with the WD, such as the boundary information, to any other positioning initiating node. The boundary message may thus be transmitted prior to receiving a request for positioning of the WD from the positioning initiating node.

In one or more example methods, the object is a vehicle, such as a car, a bus, a truck, and/or a drone.

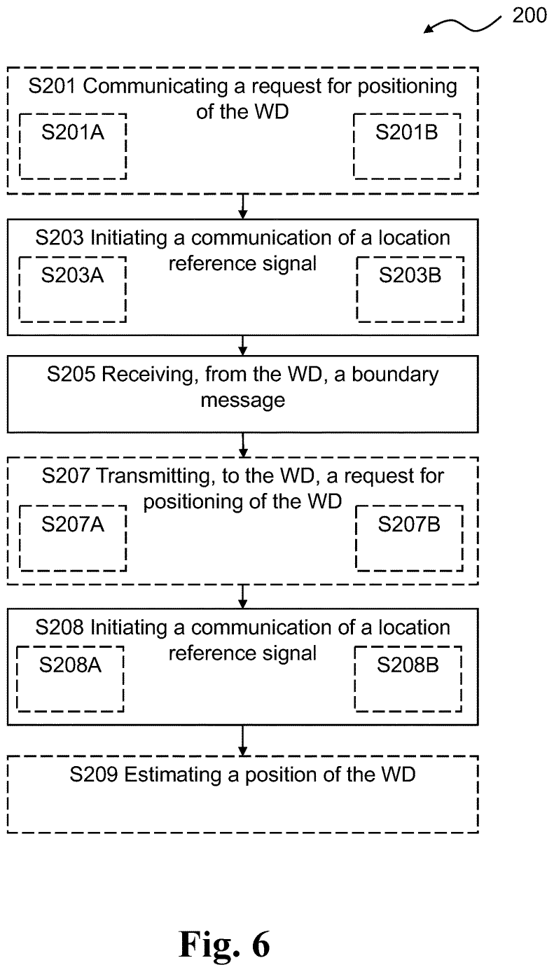

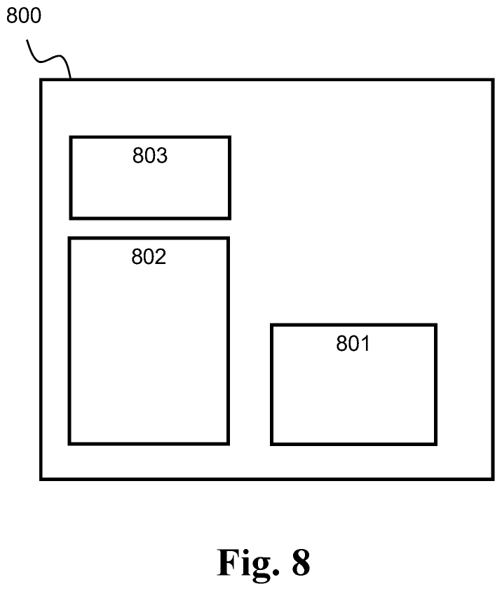

FIG. 6 shows a flow diagram of an example method 200, performed in a positioning node, according to the disclosure, for positioning of a wireless device, WD. The positioning node is the positioning node disclosed herein, such as positioning node 800 of FIG. 3 and FIG. 8. The positioning node can be seen as a node participating in a positioning procedure of a wireless device WD. In one or more example methods, the positioning node 800 may be a core network node, such as the core network node 600 of FIG. 1, FIG. 4A, FIG. 4C, and FIG. 4F, such as an LMF. In one or more example methods, the positioning node 800 may be a radio network node, such as the radio network node 400 of FIG. 1. In one or more example methods, the positioning node 800 may be a second WD, such as the WD 300C of FIG. 1 and FIGS. 4A-4D, such as an RSU.

In one or more example methods, the method 200 comprises communicating S201, S207, with the WD, a request for positioning the WD. In one or more example methods, communicating the request for positioning of the WD comprises transmitting S201A, S207A the request for positioning the WD to the WD. The positioning node thus initiates the positioning procedure for positioning the WD. The positioning procedure may be a 3GPP positioning procedure, such as one or more of an UL positioning procedure, a DL positioning procedure, a SL positioning procedure, a RTT positioning procedure, and an OTDA positioning procedure. The positioning procedure may not relate to a GPS positioning procedure.

In one or more example methods, communicating the request for positioning of the WD comprises receiving S201B, S207B a request for positioning the WD from the WD. In other words, the WD may act as the positioning initiating node.

In one or more example methods, the positioning node is a radio network node, such as the radio network node 400 of FIG. 1. This may for example be the case when the positioning procedure is an UL and/or DL positioning procedure.

In one or more example methods, the positioning node is a second WD, such as a second WD 300A, 300B, 300C of FIG. 1, such as an RSU. This may for example be the case when the positioning procedure is a SL positioning procedure.

The method 200 comprises initiating S203, S208 a communication of a location reference signal. The location reference signal may be one or more of a PRS transmitted in the UL and/or the DL, and a sidelink reference signal transmitted via the PC5 interface. In one or more example methods, communicating S203, S208 comprises transmitting S203A, S208A the location reference signaling, such as when the positioning node is the positioning initiating node. In one or more example methods, communicating S203, S208 comprises receiving S103B, S108B the location reference signaling, such as when the WD is the positioning initiating node.

The method 200 comprises receiving S205, from the WD, a boundary message indicative of one or more geometric parameters related to a physical size of an object associated with the WD. The location reference signal and the boundary message are received using a same radio access technology, such as using a 3GPP access technology. Receiving using a 3GPP access technology may comprise receiving using one or more of a 3GPP LPP, a 3GPP RRC protocol, and a 3GPP L1 protocol.

In one or more example methods, the one or more geometric parameters comprise coordinates of one or more reference points of the object, such as of an outer section, such as a boundary of the object. The reference point of the object may herein be referred to as an object reference point. The one or more reference points may be reference points, such as the reference points 1000A, 1000B, 1000C, 1000D, 1000E of the object 1000 shown in FIG. 2.

In one or more example methods, the one or more geometric parameters comprise a relative location between an antenna reference point and one or more reference points of the object. In other words, the coordinates of the one or more reference points may be indicated relative to one or more antenna reference points of the object.

In one or more example methods, the coordinates of the one or more reference points may be indicated as coordinates within a GCS or LCS, such as a coordinate system of the object.

In one or more example methods, the one or more geometric parameters comprise one or more dimensions of the object. The geometric parameters may for example indicate that the object has a first extension in a first dimension, a second extension in a second dimension, and a third extension in a third dimension. In one or more example methods, the geometric parameters may define the object as a volume object, such as a box, extending in a plurality of dimensions. The one or more dimensions may be signalled together with a (pre)defined point of the object as an object reference point. In other words, the one or more geometric parameters may indicate the extension of the object in the one or more dimensions in relation to the object reference point.

In one or more example methods, the one or more geometric parameters may comprise an ARP. The ARP may be related to the object reference point. This allows the positioning node to determine a position of the object reference point in relation to the position determined based on the antenna reference point during a positioning procedure.

In one or more example methods, the one or more geometric parameters comprise an antenna reference point coordinate within the object. The antenna reference point coordinate may be indicated as a coordinate within the GCS or LCS, such as within the coordinate system of the object.

In one or more example methods, the one or more geometric parameters comprise an antenna reference point identifier (ARP ID). In case the object comprises a plurality of antenna panels, the one or more geometric parameters may comprise an antenna reference point identifier, identifying the antenna panel in relation to which the object reference point has been determined. By providing the ARP ID, the positioning node may identify the antenna panel out of the plurality of antenna panels to be used for correctly positioning the boundaries of the object.

In one or more example methods, the one or more geometric parameters comprise an orientation parameter. The orientation parameter may indicate whether an object reference point and/or an ARP is located in the front, the back or on a side, such as a left side or right side, of the object.

In one or more example methods, the one or more geometric parameters comprise a boundary identifier (ID) indicative of a predetermined type of boundary object, such as a predetermined shape of the boundary object. In one or more example methods, a plurality of different boundary objects may be predetermined, such as a vehicle, a RSU, etc. Each of the predetermined boundary objects may have a predetermined geometric size. In one or more example methods, the boundary ID may be indicative of subcategories of the predetermined boundary objects, such as based on the size of the predetermined objects. The boundary object vehicle may for example comprise the categories small sized vehicle, medium sized vehicle, large sized vehicle, such as small sized car, medium sized car, large sized car, small sized truck, medium sized truck, large sized truck, small sized bus, medium sized bus, large sized bus, etc. Each of the boundary objects and/or subcategories of boundary objects may have a predetermined size or volume. The selected boundary object is rounded upwards to the closest boundary. In other words, if the boundaries of the object associated with the WD is larger than for example a medium sized vehicle, the object associated with the WD is classified as the next sized vehicle, such as a large sized vehicle and the boundary message would comprise the boundary ID associated with the large sized vehicle. In one or more example methods, the preconfigured boundary objects can be even finer-grained, such as designating specific car brands and/or models. Each car brand and/or model may thus have its own predetermined boundary ID, which can be indicated in the boundary message.

The object associated with the WD may be seen as an object connected to, attached to, being collocated with, and/or moving together with the WD.

In one or more example methods, the request for positioning the WD is request for positioning the WD is communicated S201, such as transmitted S201A and/or received S201B, prior to receiving S205 the boundary message.

In one or more example methods, the boundary message is received in response to transmitting S201A the request for positioning the WD. In one or more example methods, the boundary message is received together with position coordinates in a measurement report, such as a positioning estimation report. For example, the positioning estimation report may indicate what boundaries or boundary ID a position coordinate of the WD is related to. In other words, the WD may report its estimated position and information related to the boundary of the object associated with the WD, such as the geometric parameters related to the physical size of the object. In one or more example methods, the positioning estimation report may be transmitted when the WD has measured on a location reference signal and has determined its position based on the measurement.

In one or more example methods, the boundary message is received together with a measurement report, such as a positioning measurement report. For example, the WD may be equipped with multiple antenna panels and may thus have different measurements with respect to different antenna panels. In the measurement report, the WD may indicate the geometric parameters related to the physical size of the object, such as reference coordinates of the boundary of the object or a boundary ID, and the association between an ARP ID and the geometric parameters related to the physical size of the object. In one or more example methods, the measurement report may be transmitted when the WD has measured on a location reference signal transmitted from a positioning node and transmits the measurement report back to the positioning node for enabling the positioning node to determine the actual position of the WD based on the measurement report.

In one or more example methods, the boundary message may comprise a boundary capability indication indicative of whether the antenna is located at the boundary of the object or distant from the boundary of the object. The boundary capability indication may in one or more example methods indicate whether the WD is with or without boundary. Without boundary can herein be seen as the transmission and/or reception point, such as the antenna panel of the WD, is located at the outer part of the object (such as on a door of a vehicle, a bumper of the vehicle, etc).

In one or more example methods, the boundary message comprises a velocity parameter indicative of a direction and speed of the object. The velocity parameter may for example indicate whether the closest point of the object, such as the point of the object closest to a second WD, is moving closer to or away from the second WD. In one or more example methods, instead of signaling a complete boundary of the object, only the closest point to the second WD may be communicated in the boundary message.

In one or more example methods, the boundary message is received in response to transmitting S201A the request for positioning the WD.

In one or more example methods, the request for positioning the WD is communicated, such as transmitted S207A and/or received S207B, subsequent to receiving the boundary message.

In one or more example methods, the boundary message may be received as a part of, such as comprised in, the request for positioning of the WD, when the method comprises receiving S201B, S207B the request. This may for example be the case when the request for positioning is initiated from the object itself, such as from the WD associated with the object. In this case, the WD may act as a positioning initiating node. For example, the positioning request could indicate any of the geometric parameters mentioned herein, such as the use of a specific boundary or a boundary ID and a corresponding reference point.

In one or more example methods, the boundary message is received as part of a pre-configuration procedure, such as part of a network registration procedure of the WD. For example, when the positioning node is an LMF, the LMF may receive the boundary message from the WD to set up a predetermined type of boundary object associated with the WD, such as the object being a vehicle. This communication can be at the RRC level or LPP level. The LMF may, in one or more example methods, receive the boundary message from the WD during the pre-configuration procedure, which can enable the LMF to subsequently provide the geometric parameters related to a physical size of an object associated with the WD, such as the boundary information, to any other positioning initiating node. The boundary message may thus be transmitted prior to receiving a request for positioning of the WD from the positioning initiating node.

In one or more example methods, the object is a vehicle, such as a car, a bus, a truck, and/or a drone.

In one or more example methods, the method 200 comprises estimating S209 a position of the WD based on the one or more geometric parameters. The positioning node may determine an actual position of the reference points of the object, such as of the boundary of the object based on the one or mor geometric parameters and their relationship to the ARP of the antenna panel used for the positioning measurement of the WD associated with the object.

FIG. 7 shows a block diagram of an example wireless device 300A, 300B, 300C according to this disclosure. The WD 300A, 300B, 300C comprises memory circuitry 301, processor circuitry 302, and a wireless interface 303. The WD 300A, 300B, 300C may be configured to perform any of the methods disclosed in FIG. 5. In other words, the WD 300A, 300B, 300C may be configured for performing a method for determining its position (such as, its location).

The WD 300A, 300B, 300C is configured to communicate with a positioning node, such as the positioning node disclosed herein, using a wireless communication system.

The wireless interface 303 is configured for wireless communications via a wireless communication system, such as a bluetooth system, a WiFi system, or a 3GPP system, such as a 3GPP system supporting one or more of: New Radio, NR, Long Term Evolution, LTE, Narrow-band IoT, NB-IoT, and Long Term Evolution-enhanced Machine Type Communication, LTE-M, and 3GPP system operated in licensed bands or unlicensed bands.

The WD 300A, 300B, 300C is configured to communicate (such as, via the wireless interface 303) a location reference signal.

The WD 300A, 300B, 300C is configured to transmit (such as, via the wireless interface 303), to the positioning node, a boundary message indicative of one or more geometric parameters related to a physical size of an object associated with the WD.

The location reference signal and the boundary message are transmitted using a same radio access technology.

Processor circuitry 302 is optionally configured to perform any of the operations disclosed in FIG. 5 (such as any one or more of S101, S101A, S101B, S103, S103A, S103B, S105, S107, S107A, S107B, S108, S108A, S108B). The operations of the WD 300 may be embodied in the form of executable logic routines (for example, lines of code, software programs, etc.) that are stored on a non-transitory computer readable medium (for example, memory circuitry 301) and are executed by processor circuitry 302).

Furthermore, the operations of the WD 300A, 300B, 300C may be considered a method that the WD 300A, 300B, 300C is configured to carry out. Also, while the described functions and operations may be implemented in software, such functionality may also be carried out via dedicated hardware or firmware, or some combination of hardware, firmware and/or software.

Memory circuitry 301 may be one or more of: a buffer, a flash memory, a hard drive, a removable media, a volatile memory, a non-volatile memory, a random access memory (RAM), and any other suitable device. In a typical arrangement, memory circuitry 301 may include a non-volatile memory for long term data storage and a volatile memory that functions as system memory for processor circuitry 302. Memory circuitry 301 may exchange data with processor circuitry 302 over a data bus. Control lines and an address bus between memory circuitry 301 and processor circuitry 302 also may be present (not shown in FIG. 7). Memory circuitry 301 is considered a non-transitory computer readable medium.

Memory circuitry 301 may be configured to store information, such as the geographic parameters of the object, in a part of the memory.

FIG. 8 shows a block diagram of an example positioning node 800 according to this disclosure. The positioning node 800 comprises memory circuitry 801, processor circuitry 802, and a wireless interface 803. The positioning node 800 may be configured to perform any of the methods disclosed in FIG. 6. In other words, the positioning node 800 may be configured for positioning of a wireless device, WD. The positioning node 800 may be a location management function, LMF, and/or a roadside unit, RSU, and/or a radio network node, and/or a second WD performing a sidelink positioning procedure with the WD to be positioned.

The positioning node 800 is configured to communicate with a WD, such as the WD disclosed herein, using a wireless communication system.

The wireless interface 803 is configured for wireless communications via a wireless communication system, such as a bluetooth system, a WiFi system, or a 3GPP system, such as a 3GPP system supporting one or more of: New Radio, NR, Long Term Evolution, LTE, Narrow-band IoT, NB-IoT, and Long Term Evolution-enhanced Machine Type Communication, LTE-M, and 3GPP system operated in licensed bands or unlicensed bands.

The positioning node 800 is configured to initiate (such as, via the wireless interface 803) a communication of a location reference signal.

The positioning node 800 is configured to receive (such as, via the wireless interface 803), from the WD, a boundary message indicative of one or more geometric parameters related to a physical size of an object associated with the WD.

The location reference signal and the boundary message are transmitted using a same radio access technology.

Processor circuitry 802 is optionally configured to perform any of the operations disclosed in FIG. 6 (such as any one or more of S201, S201A, S201B, S203, S203A, S203B, S205, S207, S207A, S207B, S208, S208A, S208B, S209). The operations of the positioning node 800 may be embodied in the form of executable logic routines (for example, lines of code, software programs, etc.) that are stored on a non-transitory computer readable medium (for example, memory circuitry 801) and are executed by processor circuitry 802).

Furthermore, the operations of the positioning node 800 may be considered a method that the positioning node 800 is configured to carry out. Also, while the described functions and operations may be implemented in software, such functionality may also be carried out via dedicated hardware or firmware, or some combination of hardware, firmware and/or software.

Memory circuitry 801 may be one or more of: a buffer, a flash memory, a hard drive, a removable media, a volatile memory, a non-volatile memory, a random access memory (RAM), and any other suitable device. In a typical arrangement, memory circuitry 801 may include a non-volatile memory for long term data storage and a volatile memory that functions as system memory for processor circuitry 802. Memory circuitry 801 may exchange data with processor circuitry 802 over a data bus. Control lines and an address bus between memory circuitry 801 and processor circuitry 802 also may be present (not shown in FIG. 8). Memory circuitry 801 is considered a non-transitory computer readable medium.

Memory circuitry 801 may be configured to store information, such as the geographic parameters of the object, in a part of the memory.

Examples of methods and products (wireless device and positioning node) according to the disclosure are set out in the following items:

Item 1. A method performed in a wireless device, WD, for positioning of the WD, the method comprising:
communicating (S103, S108) a location reference signal, and
transmitting (S105), to a positioning node, a boundary message indicative of one or more geometric parameters related to a physical size of an object associated with the WD,
wherein the location reference signal and the boundary message are transmitted using a same radio access technology.

Item 2. The method according to Item 1, wherein the method comprises:
communicating (S101; S107), from a positioning initiating node, a request for positioning the WD.

Item 3. The method according to Item 2, wherein communicating comprises one or more of:
receiving (S101A, S107A), from a positioning initiating node, the request for positioning the WD, and
transmitting (S101B, S107B), to a positioning node, the request for positioning the WD.

Item 4. The method according to Item 3, wherein the boundary message is transmitted in response to receiving the request for positioning the WD.

Item 5. The method according to any one of Items 2 to 4, wherein the request for positioning the WD is communicated prior to transmitting the boundary message.

Item 6. The method according to Item 2 or 3, wherein the request for positioning the WD is communicated subsequent to transmitting the boundary message.

Item 7. The method according to Item 2, 3 or 6, wherein the boundary message is transmitted as part of a pre-configuration procedure.

Item 8. The method according to any one of the previous Items, wherein the one or more geometric parameters comprise one or more of:
one or more dimensions of the object,
a relative location between an antenna reference point and one or more reference points of the object,
an antenna reference point coordinate within the object,
an antenna reference point identifier,
an orientation parameter, and
a boundary identifier indicative of a predetermined type of boundary object.

Item 9. The method according to any one of the previous Items, wherein the boundary message comprises a velocity parameter indicative of a direction and speed of the object.

Item 10. The method according to any one of the previous Items, wherein the object is a vehicle.

Item 11. A method performed in a positioning node, for positioning of a WD, the method comprising:
initiating (S203) a communication of a location reference signal, and
receiving (S205), from the WD, a boundary message indicative of one or more geometric parameters related to a physical size of an object associated with the WD,
wherein the location reference signal and the boundary message are received using a same radio access technology.

Item 12. The method according to Item 11, wherein the method comprises:

communicating (S201; S207), with the WD, a request for positioning the WD.

Item 13. The method according to Item 12, wherein communicating (S201, S207) comprises one or more of:
receiving (S201A, S207A), from a positioning initiating node, the request for positioning the WD, and
transmitting (S201B, S207B), to a positioning node, the request for positioning the WD.

Item 14. The method according to Item 13, wherein the boundary message is received in response to transmitting the request for positioning the WD.

Item 15. The method according to any one of the Items 12 to 14, wherein the request for positioning the WD is communicated prior to receiving the boundary message.

Item 16. The method according to Item 12 or 13, wherein the request for positioning the WD is communicated subsequent to receiving the boundary message.

Item 17. The method according to Item 12, 13 or 16, wherein the boundary message is received as part of a pre-configuration procedure.

Item 18. The method according to any one of the Items 11 to 17, wherein the one or more geometric parameters comprise one or more of:
one or more dimensions of the object,
a relative location between an antenna reference point and one or more reference points of the object,
an antenna reference point coordinate within the object,
an antenna reference point identifier,
an orientation parameter, and
a boundary identifier indicative of a predetermined type of boundary object.

Item 19. The method according to any one of the Items 11 to 18, wherein the boundary message comprises a velocity parameter indicative of a direction and speed of the object.

Item 20. The method according to any one of the Items 11 to 19, wherein the object is a vehicle.

Item 21. The method according to any one of the Items 11 to 20, wherein the method comprises:
estimating (S209) a position of the WD based on the one or more geometric parameters.

Item 22. A wireless device comprising memory circuitry, processor circuitry, and a wireless interface, wherein the wireless device is configured to perform any of the methods according to any of Items 1-10.

Item 23. A positioning node comprising memory circuitry, processor circuitry, and a wireless interface, wherein the positioning node is configured to perform any of the methods according to any of Items 11-21.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-8 comprise some circuitries or operations which are illustrated with a solid line and some circuitries, components, features, or operations which are illustrated with a dashed line. Circuitries or operations which are comprised in a solid line are circuitries, components, features or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method performed in a wireless device (WD) for positioning of the WD, the method comprising:
communicating a location reference signal, and
transmitting, to a positioning node, a boundary message indicative of one or more geometric parameters related to a physical size of an object associated with the WD,
wherein the location reference signal and the boundary message are transmitted using a same radio access technology.

2. The method according to claim 1, wherein the method comprises:
communicating, from a positioning initiating node, a request for positioning the WD.

3. The method according to claim 2, wherein communicating comprises one or more of:
receiving, from a positioning initiating node, the request for positioning the WD, and
transmitting, to a positioning node, the request for positioning the WD.

4. The method according to claim 3, wherein the boundary message is transmitted in response to receiving the request for positioning the WD.

5. The method according to claim 2, wherein the request for positioning the WD is communicated prior to transmitting the boundary message.

6. The method according to claim 2, wherein the request for positioning the WD is communicated subsequent to transmitting the boundary message.

7. The method according to claim 2, wherein the boundary message is transmitted as part of a pre-configuration procedure.

8. The method according to claim 1, wherein the one or more geometric parameters comprise one or more of:
one or more dimensions of the object,
a relative location between an antenna reference point and one or more reference points of the object,
an antenna reference point coordinate within the object,
an antenna reference point identifier,
an orientation parameter,
a boundary identifier indicative of a predetermined type of boundary object, and
a velocity parameter indicative of a direction and speed of the object.

9. The method according to claim 1, wherein the boundary message comprises a velocity parameter indicative of a direction and speed of the object.

10. The method according to claim 1, wherein the object is a vehicle.

11. A method performed in a positioning node, for positioning of a WD, the method comprising:
initiating a communication of a location reference signal, and
receiving, from the WD, a boundary message indicative of one or more geometric parameters related to a physical size of an object associated with the WD,
wherein the location reference signal and the boundary message are received using a same radio access technology.

12. The method according to claim 11, wherein the method comprises:
communicating, with the WD, a request for positioning the WD.

13. The method according to claim 12, wherein communicating comprises one or more of:
receiving, from a positioning initiating node, the request for positioning the WD, and
transmitting, to a positioning node, the request for positioning the WD.

14. The method according to claim 13, wherein the boundary message is received in response to transmitting the request for positioning the WD.

15. The method according to claim 12, wherein the request for positioning the WD is communicated prior to receiving the boundary message.

16. The method according to claim 12, wherein the request for positioning the WD is communicated subsequent to receiving the boundary message.

17. The method according to claim 12, wherein the boundary message is received as part of a pre-configuration procedure.

18. The method according to claim 11, wherein the one or more geometric parameters comprise one or more of:
one or more dimensions of the object,
a relative location between an antenna reference point and one or more reference points of the object, an antenna reference point coordinate within the object,
an antenna reference point identifier,
an orientation parameter, and
a boundary identifier indicative of a predetermined type of boundary object.

19. The method according to claim 11, wherein the boundary message comprises a velocity parameter indicative of a direction and speed of the object.

20. The method according to claim 11, wherein the object is a vehicle.

21-23. (canceled)
